(19) United States
(12) Patent Application Publication
(10) Pub. No.: US 2018/0269713 A1
(43) Pub. Date: Sep. 20, 2018

(54) Solar Battery System

(71) Applicant: Jackson Bead, Federal, WA (US)

(72) Inventor: Jackson Bead, Federal, WA (US)

(21) Appl. No.: 15/459,159

(22) Filed: Mar. 15, 2017

(51) Int. Cl. H02J 7/35; H02J 7/00; H02S 40/38; H02S 40/32

(52) U.S. Cl. CPC H02J 7/355; H02J 7/0045; H02S 40/32; H02S 40/38; H02J 7/0013

(57) ABSTRACT

A solar battery system includes a power unit that is selectively positioned in a remote location with respect to electricity. A charging unit is provided and the charging unit converts solar energy into electrical energy. The charging unit is electrically coupled to the power unit to charge the power unit. An electrical device is provided and the electrical device is selectively manipulated. The electrical device has a power cord and the power cord is selectively plugged into the power unit. In this way the electrical device is usable in the remote location.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to battery devices and more particularly pertains to a new battery device for powering an electrical device in a remote location with respect to electricity.

### BRIEF SUMMARY OF THE INVENTION

An embodiment of the disclosure meets the needs presented above by generally comprising a power unit that is selectively positioned in a remote location with respect to electricity. A charging unit is provided and the charging unit converts solar energy into electrical energy. The charging unit is electrically coupled to the power unit to charge the power unit. An electrical device is provided and the electrical device is selectively manipulated. The electrical device has a power cord and the power cord is selectively plugged into the power unit. In this way the electrical device is usable in the remote location.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a solar battery system according to an embodiment of the disclosure.

FIG. 2 is a schematic view of an embodiment of the disclosure.

### DETAILED DESCRIPTION OF THE INVENTION

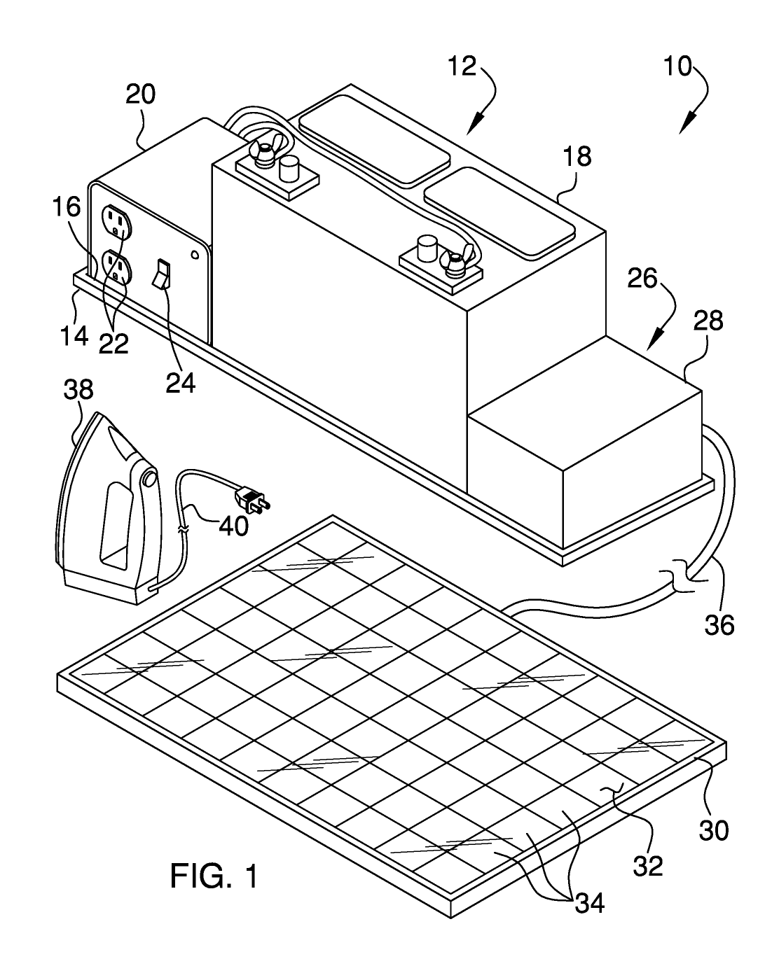

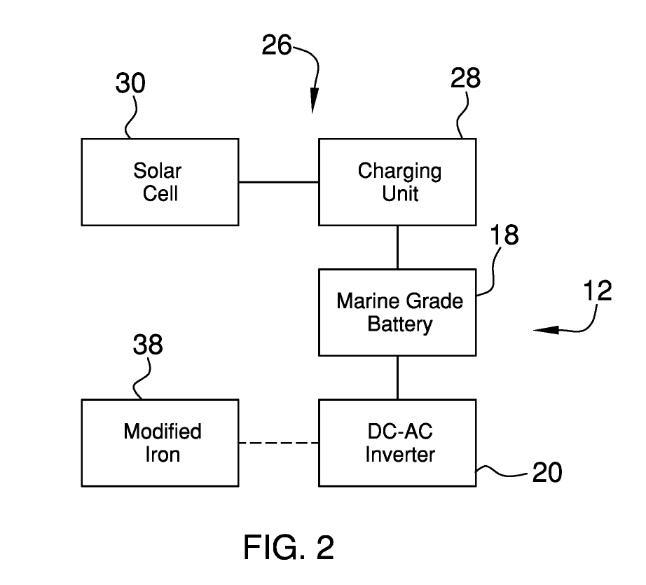

With reference now to the drawings, and in particular to FIGS. 1 through 2 thereof, a new battery device embodying the principles and concepts of an embodiment of the disclosure and generally designated by the reference numeral 10 will be described.

As best illustrated in FIGS. 1 through 2, the solar battery system 10 generally comprises a power unit 12 that is selectively positioned in a remote location with respect to electricity. The remote location may be a third world country, a campsite or any other location that does not have access to electrical power. The power unit 12 comprises a panel 14 that has a top surface 16. At least one battery 18 is provided and the at least one battery 18 is positioned on the top surface 16. The at least one battery 18 may be a deep cycle, lead acid marine battery or the like. Moreover, the at least one battery 18 may have a power rating of at least 100 amp hours.

An inverter 20 is provided and the inverter 20 is positioned on the top surface 16. The inverter 20 is electrically coupled to the at least one battery 18 and the inverter 20 converts DC voltage into AC voltage. The inverter 20 includes a pair of outlets 22 and each of the outlets 22 is in electrical communication with the inverter 20. In this way each of the outlets 22 receives the AC voltage. Each of the outlets 22 may comprise a female electrical outlet or the like. A power switch 24 is movably coupled to the inverter 20 and the power switch 24 is selectively manipulated. The power switch 24 is in electrical communication with the inverter 20 to turn the inverter 20 on and off. The inverter 20 may be an electronic inverter 20 of any conventional design.

A charging unit 26 is provided to convert solar energy into electrical energy. The charging unit 26 is electrically coupled to the power unit 12 to charge the power unit 12. The charging unit 26 comprises a charger 28 that is positioned on the top surface 16 of the panel 14. The charger 28 is electrically coupled to the at least one battery 18. Moreover, the charger 28 may be a battery charger may be an electronic deep cycle charger 28 or the like.

A solar panel 30 is provided and the solar panel 30 is selectively exposed to sunlight. In this way the solar panel 30 converts sunlight into electrical energy. The solar panel 30 is electrically coupled to the charger 28 such that the solar panel 30 charges the battery. The solar panel 30 has a first surface 32 and the first surface 32 comprises a plurality of solar cells 34. The solar panel 30 may have an operational output ranging between 0.25 kW and 0.5 kW. A conductor 36 is electrically coupled between the solar panel 30 and the charger 28. In this way the solar panel 30 may be remotely positioned with respect to the power unit 12. The conductor 36 may have a length ranging between approximately 1.5 m and 3.0 m.

An electrical device 38 is provided and the electrical device 38 is selectively manipulated. The electrical device 38 has a power cord 40 and the power cord 40 is selectively plugged into a selected one of the outlets 22. In this way such that the electrical device 38 is usable in a remote location with respect to electricity. The electrical device 38 may be an iron, a skillet or any other electrical device 38 having a power consumption ranging between approximately 800 W and 1200 W.

In use, the power unit 12 is transported to the remote location and the solar panel 30 is positioned to be exposed to sunlight. In this way the solar panel 30 charges the at least one battery 18. The electrical device 38 is selectively plugged into the selected outlet and the power switch 24 is manipulated to turn the inverter 20 on. In this way the electrical device 38 is usable in the remote location.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A solar battery system comprising:
a power unit being configured to be positioned in a remote location with respect to electricity;
a charging unit being configured to convert solar energy into electrical energy, said charging unit being electrically coupled to said power unit such that said charging unit charges said power unit; and
an electrical device being configured to be manipulated, said electrical device having a power cord, said power cord being selectively plugged into said power unit such that said electrical device is usable in the remote location.

2. The system according to claim 1, wherein said power unit comprises a panel having a top surface.

3. The system according to claim 2, further comprising at least one battery being positioned on said top surface.

4. The system according to claim 1, further comprising an inverter being positioned on said top surface, said inverter being electrically coupled to said at least one battery, said inverter converting DC voltage into AC voltage, said inverter including a pair of outlets, each of said outlets being in electrical communication with said inverter such that each of said outlets receives the AC voltage.

5. The system according to claim 3, wherein said charging unit comprises a charger being positioned on said top surface of said panel, said charger being electrically coupled to said at least one battery.

6. The system according to claim 5, further comprising a solar panel being configured to be exposed to sunlight thereby facilitating said solar panel to convert sunlight into electrical energy, said solar panel being electrically coupled to said charger such that said solar panel charges said battery, said solar panel having a first surface, said first surface comprising a plurality of solar cells.

7. A solar battery system comprising:
a power unit being configured to be positioned in a remote location with respect to electricity, said power unit comprising:
a panel having a top surface,
at least one battery being positioned on said top surface, and
an inverter being positioned on said top surface, said inverter being electrically coupled to said at least one battery, said inverter converting DC voltage into AC voltage, said inverter including a pair of outlets, each of said outlets being in electrical communication with said inverter such that each of said outlets receives the AC voltage;
a charging unit being configured to convert solar energy into electrical energy, said charging unit being electrically coupled to said power unit such that said charging unit charges said power unit, said charging unit comprising:
a charger being positioned on said top surface of said panel, said charger being electrically coupled to said at least one battery, and
a solar panel being configured to be exposed to sunlight thereby facilitating said solar panel to convert sunlight into electrical energy, said solar panel being electrically coupled to said charger such that said solar panel charges said battery, said solar panel having a first surface, said first surface comprising a plurality of solar cells; and
an electrical device being configured to be manipulated, said electrical device having a power cord, said power cord being selectively plugged into said power unit such that said electrical device is usable in the remote location.
